(19) United States
(12) Patent Application Publication
(10) Pub. No.: US 2014/0282054 A1
(43) Pub. Date: Sep. 18, 2014

(54) COMPENSATING FOR USER SENSORY IMPAIRMENT IN WEB REAL-TIME COMMUNICATIONS (WEBRTC) INTERACTIVE SESSIONS, AND RELATED METHODS, SYSTEMS, AND COMPUTER-READABLE MEDIA

(71) Applicant: Avaya Inc., Basking Ridge, NJ (US)

(72) Inventor: John H. Yoakum, Cary, NC (US)

(21) Appl. No.: 13/835,913

(22) Filed: Mar. 15, 2013

(51) Int. Cl. H04L 29/06

(52) U.S. Cl. CPC H04L 65/40
USPC 715/744

(57) ABSTRACT

Compensating for user sensory impairment in Web Real-Time Communications (WebRTC) interactive sessions, and related methods, systems, and computer-readable media are disclosed. In this regard, in one embodiment, a method for compensating for a user sensory impairment in a WebRTC interactive session is provided. The method comprises receiving, by a computing device, an indication of user sensory impairment. The method further comprises receiving a content of a WebRTC interactive flow directed to the computing device. The method also comprises modifying, by the computing device, the content of the WebRTC interactive flow based on the indication of user sensory impairment. The method additionally comprises rendering the modified content of the WebRTC interactive flow. In this manner, a WebRTC interactive flow may be enhanced to compensate for a user sensory impairment, and thus the user's comprehension of the WebRTC interactive session may be improved.

### BACKGROUND

1. Field of the Disclosure

The technology of the disclosure relates generally to Web Real-Time Communications (WebRTC) interactive sessions.

2. Technical Background

Web Real-Time Communications (WebRTC) represents an ongoing effort to develop industry standards for integrating real-time communications functionality into web clients, such as web browsers, to enable direct interaction with other web clients. This real-time communications functionality is accessible by web developers via standard markup tags, such as those provided by version 5 of the Hypertext Markup Language (HTML5), and client-side scripting Application Programming Interfaces (APIs) such as JavaScript APIs. More information regarding WebRTC may be found in “WebRTC: APIs and RTCWEB Protocols of the HTML5 Real-Time Web” by Alan B. Johnston and Daniel C. Burnett (2012 Digital Codex LLC), which is incorporated in its entirety herein by reference.

WebRTC provides built-in capabilities for establishing real-time video, audio, and/or data streams in both point-to-point interactive sessions, as well as multi-party interactive sessions. The WebRTC standards are currently under joint development by the World Wide Web Consortium (W3C) and the Internet Engineering Task Force (IETF). Information on the current state of WebRTC standards can be found at, e.g., http://www.w3c.org and http://www/ietf.org.

WebRTC does not provide built-in accessibility capabilities to allow users affected by a sensory impairment, such as a hearing or vision deficiency, to optimize their WebRTC interactive session experience. While the audio and video output of a user's computing device may be manually adjusted, such adjustments typically affect all audio and video generated by the computing device, and are not limited to a WebRTC interactive session. Moreover, a user may be unable to adequately optimize a WebRTC interactive session through manual adjustment. Consequently, users may face challenges in attempting to customize their WebRTC interactive session to compensate for a sensory impairment.

### SUMMARY OF THE DETAILED DESCRIPTION

Embodiments disclosed in the detailed description provide compensating for user sensory impairment in Web Real-Time Communications (WebRTC) interactive sessions. Related methods, systems, and computer-readable media are also disclosed. In this regard, in one embodiment, a method for compensating for user sensory impairment in a WebRTC interactive session is provided. The method comprises receiving, by a computing device, an indication of user sensory impairment. The method further comprises receiving a content of a WebRTC interactive flow directed to the computing device. The method also comprises modifying, by the computing device, the content of the WebRTC interactive flow based on the indication of user sensory impairment. The method additionally comprises rendering the modified content of the WebRTC interactive flow. In this manner, a WebRTC interactive flow may be enhanced to compensate for a user sensory impairment, and thus the user's comprehension of the WebRTC interactive session may be improved.

In another embodiment, a system for compensating for a user sensory impairment in a WebRTC interactive session is provided. The system comprises at least one communications interface, and a computing device associated with the at least one communications interface and comprising a sensory impairment compensation agent. The sensory impairment compensation agent is configured to receive an indication of user sensory impairment. The sensory impairment compensation agent is further configured to receive a content of a WebRTC interactive flow directed to the computing device. The sensory impairment compensation agent is also configured to modify the content of the WebRTC interactive flow based on the indication of user sensory impairment. The sensory impairment compensation agent is additionally configured to render the modified content of the WebRTC interactive flow.

In another embodiment, a non-transitory computer-readable medium is provided. The non-transitory computer-readable medium has stored thereon computer-executable instructions to cause a processor to implement a method comprising receiving, by a computing device, an indication of user sensory impairment. The method implemented by the computer-executable instructions further comprises receiving a content of a WebRTC interactive flow directed to the computing device. The method implemented by the computer-executable instructions also comprises modifying, by the computing device, the content of the WebRTC interactive flow based on the indication of user sensory impairment. The method implemented by the computer-executable instructions additionally comprises rendering the modified content of the WebRTC interactive flow.

### BRIEF DESCRIPTION OF THE FIGURES

The accompanying drawing figures incorporated in and forming a part of this specification illustrate several aspects of the disclosure, and together with the description serve to explain the principles of the disclosure.

FIG. 1 is a conceptual diagram showing an exemplary “triangle” topology of a Web Real-Time Communications (WebRTC) interactive session, including a computing device comprising a sensory impairment compensation agent;

FIG. 2 is a flowchart illustrating exemplary operations for compensation for user sensory impairment in WebRTC interactive sessions;

FIGS. 3A and 3B are flowcharts illustrating more detailed exemplary operations for compensating for user sensory impairment in WebRTC interactive sessions; and

FIG. 4 is a block diagram of an exemplary processor-based system that may include the sensory impairment compensation agent of FIG. 1.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description provide compensating for user sensory impairment in Web Real-Time Communications (WebRTC) interactive sessions. Related methods, systems, and computer-readable media are also disclosed. In this regard, in one embodiment, a method for compensating for user sensory impairment in a WebRTC interactive session is provided. The method comprises receiving, by a computing device, an indication of user sensory impairment. The method further comprises receiving a content of a WebRTC interactive flow directed to the computing device. The method also comprises modifying, by the computing device, the content of the WebRTC interactive flow based on the indication of user sensory impairment. The method additionally comprises rendering the modified content of the WebRTC interactive flow. In this manner, a WebRTC interactive flow may be enhanced to compensate for a user sensory impairment, and thus the user's comprehension of the WebRTC interactive session may be improved.

In this regard, FIG. 1 shows an exemplary interactive communications system 10 providing compensation for user sensory impairment in WebRTC interactive sessions as disclosed herein. In particular, the system 10 includes a sensory impairment compensation agent 12. The sensory impairment compensation agent 12 provides a point at which a WebRTC interactive flow may be modified to compensate for a user sensory impairment, as discussed in greater detail below. As non-limiting examples, a user sensory impairment may include a hearing impairment such as hearing loss or difficulty with speech perception, or a vision impairment such as color blindness.

Before discussing details of the sensory impairment compensation agent 12, the establishment of a WebRTC interactive session in the system 10 of FIG. 1 is first generally described. As used herein, a WebRTC interactive session refers to operations for carrying out a WebRTC offer/answer exchange, establishing a peer connection, and commencing a WebRTC interactive flow between two or more endpoints. A WebRTC interactive flow may comprise an interactive media flow and/or an interactive data flow between the two or more endpoints. An interactive media flow of a WebRTC interactive flow may comprise a real-time audio stream and/or a real-time video stream.

In the system 10 of FIG. 1, a computing device 14 of a user 16 executes a web client 18. In some embodiments, the computing device 14 may be any computing device having network communications capabilities, such as a smartphone, a tablet computer, a dedicated web appliance, or a desktop computer, as non-limiting examples. The web client 18 may be a web browser application, a dedicated communications application, or an interface-less application such as a daemon or service application, as non-limiting examples. In this example, the web client 18 comprises a scripting engine 20 and a WebRTC functionality provider 22 in this embodiment. The scripting engine 20 enables client-side applications written in a scripting language, such as JavaScript, to be executed within the web client 18. The scripting engine 20 also provides an application programming interface (API) (not shown) to facilitate communications with other functionality providers within the web client 18 and/or the computing device 14, and/or with other web clients, user devices, or web servers. The WebRTC functionality provider 22 implements the protocols, codecs, and APIs necessary to enable real-time interactive sessions via WebRTC. The scripting engine 20 and the WebRTC functionality provider 22 are communicatively coupled via a set of defined APIs, as indicated by bidirectional arrow 24.

The system 10 of FIG. 1 also includes a web application server 26, which serves a WebRTC-enabled web application (not shown) to requesting web clients, such as the web client 18. In some embodiments, the web application server 26 may be a single server, while in some applications the web application server 26 may comprise multiple servers that are communicatively coupled to each other. Also in the system 10 of FIG. 1 is a computing device 28. The computing device 28 may be any computing device having network communications capabilities, such as a smartphone, a tablet computer, a dedicated web appliance, or a desktop computer, as non-limiting examples. In some embodiments, the computing device 28 may execute a web client (not shown) such as, by way of non-limiting examples, a web browser application, a dedicated communications application, or an interface-less application such as a daemon or service application.

FIG. 1 further illustrates the characteristic WebRTC “triangle” topology that results from establishing a WebRTC interactive session between the web client 18 and the computing device 28. To establish a WebRTC interactive session, the web client 18 and the computing device 28 both download the same WebRTC web application (not shown) from the web application server 26. In some embodiments, the WebRTC web application comprises an HTML5/JavaScript web application that provides a rich user interface using HTML5, and uses JavaScript to handle user input and to communicate with the web application server 26.

The web client 18 and the computing device 28 then establish secure web connections 30 and 32, respectively, with the web application server 26, and engage in a WebRTC session establishment exchange 34. In some embodiments, the WebRTC session establishment exchange 34 includes a WebRTC offer/answer exchange accomplished through an exchange of WebRTC session description objects (not shown). Once the WebRTC session establishment exchange 34 is complete, a WebRTC interactive flow 36 may be established via a secure peer connection 38 directly between the web client 18 and the computing device 28. Accordingly, in FIG. 1 the vertices of the WebRTC “triangle” are the web application server 26, the web client 18, and the computing device 28. The edges of the “triangle” are represented by the secure web connections 30 and 32 and the secure peer connection 38.

It is to be understood that some embodiments may utilize topographies other than the WebRTC “triangle” topography illustrated in FIG. 1. For example, some embodiments may employ a “trapezoid” topography in which two web servers communicate directly with each other via protocols such as Session Initiation Protocol (SIP) or Jingle, as non-limiting examples. It is to be further understood that the computing device 14 and/or the computing device 28 may comprise a SIP client device, a Jingle client device, or a Public Switched Telephone Network (PTSN) gateway device that is communicatively coupled to a telephone.

As noted above, the WebRTC functionality provider 22 implements protocols, codecs, and APIs necessary to enable real-time interactive sessions via WebRTC. However, the WebRTC functionality provider 22 may not include accessibility options for optimizing a WebRTC interactive session for the user 16 affected by a sensory impairment. In this regard, the sensory impairment compensation agent 12 of FIG. 1 is provided. In some embodiments, the sensory impairment compensation agent 12 is implemented as an extension or plug-in for the web client 18 for receiving and modifying a content 40 of the WebRTC interactive flow 36 from the WebRTC functionality provider 22. The content 40 may include, for example, a real-time audio stream and/or a real-time video stream. In some embodiments, the sensory impairment compensation agent 12 may be integrated into the WebRTC functionality provider 22.

As indicated by bidirectional arrow 42, the sensory impairment compensation agent 12 receives an indication of user sensory impairment 44. The indication of user sensory impairment 44 provides data regarding a sensory impairment affecting the user 16. The indication of user sensory impairment 44, in some embodiments, may specify a type of the sensory impairment (e.g., a hearing impairment and/or a visual impairment), a degree of the sensory impairment, and/or a corrective measure to compensate for the sensory impairment.

Based on the indication of user sensory impairment 44, the sensory impairment compensation agent 12 modifies the content 40 of the WebRTC interactive flow 36 to improve the user 16's comprehension of the WebRTC interactive flow 36. For example, in embodiments where the indication of user sensory impairment 44 indicates a hearing impairment, the sensory impairment compensation agent 12 may modify a real-time audio stream of the content 40 of the WebRTC interactive flow 36. Modifications to the real-time audio stream may include modifying an amplitude of a frequency in the real-time audio stream, and/or substituting one frequency for another in the real-time audio stream (i.e., “audio colorization”). Likewise, in embodiments where the indication of user sensory impairment 44 indicates a vision impairment, the sensory impairment compensation agent 12 may modify a real-time video stream of the content 40 of the WebRTC interactive flow 36. Modifications to the real-time video stream may include modifying an intensity of a color in the real-time video stream, and/or substituting one color for another in the real-time video stream.

After modifying the content 40 of the WebRTC interactive flow 36, the sensory impairment compensation agent 12 renders a modified content 46 of the WebRTC interactive flow 36 for consumption by the user 16. In some embodiments, rendering the modified content 46 may comprise generating audio and/or video output to the user 16 based on the modified content 46.

Some embodiments may provide that the sensory impairment compensation agent 12 may receive the indication of user sensory impairment 44 by accessing a user-provided data file 48 supplied by the user 16. The user-provided data file 48 may indicate a type and/or a degree of user sensory impairment affecting the user 16, and may be generated by an assessment administered to the user 16 by a medical professional. The user-provided data file 48 may also include a corrective measure to compensate for user sensor impairment. In some embodiments, the sensory impairment compensation agent 12 itself may administer a sensory impairment assessment 50 to the user 16. The sensory impairment compensation agent 12 may then receive the indication of user sensory impairment 44 based on a result of the sensory impairment assessment 52. Some embodiments may provide that the sensory impairment compensation agent 12 receives the indication of user sensory impairment 44 by accessing a user profile 54 associated with the user 16. The user profile 54 may store previously-determined information about a sensory impairment of the user 16, enabling the sensory impairment compensation agent 12 to subsequently access the information from the user profile 54 without requiring additional input from or testing of the user 16.

To generally describe exemplary operations of the sensory impairment compensation agent 12 of FIG. 1 for compensating for user sensory impairment in WebRTC interactive sessions, FIG. 2 is provided. In this example of FIG. 2, operations begin with the sensory impairment compensation agent 12 of the computing device 14 receiving the indication of user sensory impairment 44 (block 56). In some embodiments, the indication of user sensory impairment 44 may comprise data obtained from the user-provided data file 48, from the result of a sensory impairment assessment 52, and/or from the user profile 54, as non-limiting examples.

With continuing reference to FIG. 2, the sensory impairment compensation agent 12 next receives a content 40 of the WebRTC interactive flow 36 directed to the computing device 14 (block 58). The content 40 may include a real-time audio stream and/or a real-time video stream of the WebRTC interactive flow 36. The sensory impairment compensation agent 12 modifies the content 40 based on the indication of user sensory impairment 44 (block 60). For example, in embodiments where the indication of user sensory impairment 44 indicates a hearing impairment, the sensory impairment compensation agent 12 may modify a real-time audio stream of the content 40 of the WebRTC interactive flow 36. Similarly, in embodiments where the indication of user sensory impairment 44 indicates a vision impairment, the sensory impairment compensation agent 12 may modify a real-time video stream of the content 40 of the WebRTC interactive flow 36. The sensory impairment compensation agent 12 then renders the modified content 46 of the WebRTC interactive flow 36 (block 62).

FIGS. 3A and 3B are provided to illustrate in more detail an exemplary generalized process for the sensory impairment compensation agent 12 of FIG. 1 to compensate for user sensory impairment in WebRTC interactive sessions. FIG. 3A details operations for receiving an indication of user sensory impairment from one of a number of potential sources. FIG. 3B shows operations for receiving and modifying a content of a WebRTC interactive flow based on the indication of user sensory impairment. For illustrative purposes, FIGS. 3A and 3B refer to elements of the system 10 and the sensory impairment compensation agent 12 of FIG. 1.

Referring now to FIG. 3A, the sensory impairment compensation agent 12 first determines a source for an indication of user sensory impairment, such as the indication of user sensory impairment 44 of FIG. 1 (block 64). In some embodiments, the indication of user sensory impairment 44 may be supplied by a user-provided data file, such as the user-provided data file 48 of FIG. 1. For example, a user 16 may provide a data file that is generated by or obtained from a medical professional and that specifies the type and/or degree of the user sensory impairment and/or corrective measures to compensate for the user sensory impairment. In this scenario, the sensory impairment compensation agent 12 accesses the user-provided data file 48 (block 66). The sensory impairment compensation agent 12 then determines the indication of user sensory impairment 44 based on the user-provided data file 48 (block 68).

If the sensory impairment compensation agent 12 determines at block 64 that the indication of user sensory impairment 44 is provided by a result of a sensory impairment assessment 52, the sensory impairment compensation agent 12 administers a sensory impairment assessment 50 to the user 16 to assess the type and degree of the user sensory impairment (block 70). For instance, the sensory impairment compensation agent 12 may provide an interactive hearing and/or vision test to evaluate whether the user 16 is affected by a user sensory impairment. The sensory impairment compensation agent 12 then determines the indication of user sensory impairment 44 based on a result of the sensory impairment assessment, such as the result of the sensory impairment assessment 52 (block 72).

In embodiments where the indication of user sensory impairment 44 is determined based on a user-provided data file 48 or a result of a sensory impairment assessment 52, the sensory impairment compensation agent 12 may optionally store the indication of user sensory impairment 44 in a user profile, such as the user profile 54, for later access (block 74). Processing then continues at block 76 of FIG. 3B.

Returning to the decision point at block 64 of FIG. 3A, the sensory impairment compensation agent 12 may determine at block 64 that the indication of user sensory impairment 44 is provided by a previously-generated user profile, such as a user profile 54 stored at block 74. Accordingly, the sensory impairment compensation agent 12 accesses the user profile 54 (block 78), and determines the indication of user sensory impairment 44 based on the user profile 54 (block 80). Processing then continues at block 76 of FIG. 3B.

Referring now to FIG. 3B, the sensory impairment compensation agent 12 next receives a content of a WebRTC interactive flow, such as the content 40 of the WebRTC interactive flow 36 of FIG. 1 (block 76). The sensory impairment compensation agent 12 then determines whether the indication of user sensory impairment 44 includes an indication of user hearing impairment (block 82). If not, processing proceeds to block 84. If the indication of user sensory impairment 44 does include an indication of user hearing impairment, the sensory impairment compensation agent 12 modifies a real-time audio stream of the content 40 of the WebRTC interactive flow 36 based on the indication of user sensory impairment 44 (block 86). Processing then proceeds to block 84.

The sensory impairment compensation agent 12 next determines whether the indication of user sensory impairment 44 includes an indication of user vision impairment (block 84). If not, processing proceeds to block 88. If the indication of user sensory impairment 44 does include an indication of user vision impairment, the sensory impairment compensation agent 12 modifies a real-time video stream of the content 40 of the WebRTC interactive flow 36 based on the indication of user sensory impairment 44 (block 90). Processing then proceeds to block 88. At block 88, the sensory impairment compensation agent 12 renders a modified content of the WebRTC interactive flow, such as the modified content 46 of the WebRTC interactive flow 36 of FIG. 1.

FIG. 4 provides a schematic diagram representation of a processing system 92 in the exemplary form of an exemplary computer system 94 adapted to execute instructions to perform the functions described herein. In some embodiments, the processing system 92 may execute instructions to perform the functions of the sensory impairment compensation agent 12 of FIG. 1. In this regard, the processing system 92 may comprise the computer system 94, within which a set of instructions for causing the processing system 92 to perform any one or more of the methodologies discussed herein may be executed. The processing system 92 may be connected (as a non-limiting example, networked) to other machines in a local area network (LAN), an intranet, an extranet, or the Internet. The processing system 92 may operate in a client-server network environment, or as a peer machine in a peer-to-peer (or distributed) network environment. While only a single processing system 92 is illustrated, the terms “controller” and “server” shall also be taken to include any collection of machines that individually or jointly execute a set (or multiple sets) of instructions to perform any one or more of the methodologies discussed herein. The processing system 92 may be a server, a personal computer, a desktop computer, a laptop computer, a personal digital assistant (PDA), a computing pad, a mobile device, or any other device and may represent, as non-limiting examples, a server or a user's computer.

The exemplary computer system 94 includes a processing device or processor 96, a main memory 98 (as non-limiting examples, read-only memory (ROM), flash memory, dynamic random access memory (DRAM) such as synchronous DRAM (SDRAM), etc.), and a static memory 100 (as non-limiting examples, flash memory, static random access memory (SRAM), etc.), which may communicate with each other via a bus 102. Alternatively, the processing device 96 may be connected to the main memory 98 and/or the static memory 100 directly or via some other connectivity means.

The processing device 96 represents one or more processing devices such as a microprocessor, central processing unit (CPU), or the like. More particularly, the processing device 96 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 96 is configured to execute processing logic in instructions 104 and/or cached instructions 106 for performing the operations and steps discussed herein.

The computer system 94 may further include a communications interface in the form of a network interface device 108. It also may or may not include an input 110 to receive input and selections to be communicated to the computer system 94 when executing the instructions 104, 106. It also may or may not include an output 112, including but not limited to display(s) 114. The display(s) 114 may be a video display unit (as non-limiting examples, a liquid crystal display (LCD) or a cathode ray tube (CRT)), an alphanumeric input device (as a non-limiting example, a keyboard), a cursor control device (as a non-limiting example, a mouse), and/or a touch screen device (as a non-limiting example, a tablet input device or screen).

The computer system 94 may or may not include a data storage device 115 that includes using drive(s) 116 to store the functions described herein in a computer-readable medium 118, on which is stored one or more sets of instructions 120 (e.g., software) embodying any one or more of the methodologies or functions described herein. The functions can include the methods and/or other functions of the processing system 92, a participant user device, and/or a licensing server, as non-limiting examples. The one or more sets of instructions 120 may also reside, completely or at least partially, within the main memory 98 and/or within the processing device 96 during execution thereof by the computer system 94. The main memory 98 and the processing device 96 also constitute machine-accessible storage media. The instructions 104, 106, and/or 120 may further be transmitted or received over a network 122 via the network interface device 108. The network 122 may be an intra-network or an inter-network.

While the computer-readable medium 118 is shown in an exemplary embodiment to be a single medium, the term “machine-accessible storage medium” should be taken to include a single medium or multiple media (as non-limiting examples, a centralized or distributed database, and/or associated caches and servers) that store the one or more sets of instructions 120. The term “machine-accessible storage medium” shall also be taken to include any medium that is capable of storing, encoding, or carrying a set of instructions 104, 106, and/or 120 for execution by the machine, and that cause the machine to perform any one or more of the methodologies disclosed herein. The term “machine-accessible storage medium” shall accordingly be taken to include, but not be limited to, solid-state memories, optical and magnetic media, and carrier wave signals.

The embodiments disclosed herein may be embodied in hardware and in instructions that are stored in hardware, and may reside, as non-limiting examples, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. As non-limiting examples, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for compensating for a user sensory impairment in a Web Real-Time Communications (WebRTC) interactive session, comprising:
receiving, by a computing device, an indication of user sensory impairment;
receiving a content of a WebRTC interactive flow directed to the computing device;
modifying, by the computing device, the content of the WebRTC interactive flow based on the indication of user sensory impairment; and
rendering the modified content of the WebRTC interactive flow.

2. The method of claim 1, wherein receiving the indication of user sensory impairment comprises receiving an indication of user hearing impairment; and
wherein modifying the content of the WebRTC interactive flow comprises modifying a real-time audio stream of the WebRTC interactive flow based on the indication of user hearing impairment.

3. The method of claim 2, wherein modifying the real-time audio stream of the WebRTC interactive flow comprises modifying an amplitude of a first frequency in the real-time audio stream or substituting a second frequency for a third frequency in the real-time audio stream, or a combination thereof, based on the indication of user hearing impairment.

4. The method of claim 1, wherein receiving the indication of user sensory impairment comprises receiving an indication of user vision impairment; and
wherein modifying the content of the WebRTC interactive flow comprises modifying a real-time video stream of the WebRTC interactive flow based on the indication of user vision impairment.

5. The method of claim 4, wherein modifying the real-time video stream of the WebRTC interactive flow comprises modifying an intensity of a first color in the real-time video stream or substituting a second color for a third color in the real-time video stream, or a combination thereof, based on the indication of user vision impairment.

6. The method of claim 1, wherein receiving the indication of user sensory impairment comprises:
administering a sensory impairment assessment by the computing device; and
determining the indication of user sensory impairment based on a result of the sensory impairment assessment.

7. The method of claim 1, wherein receiving the indication of user sensory impairment comprises:
accessing a user-provided data file that indicates the user sensory impairment; and
determining the indication of user sensory impairment based on the user-provided data file.

8. The method of claim 1, further comprising storing the indication of user sensory impairment as a user profile; and
wherein receiving the indication of user sensory impairment comprises:
accessing the user profile; and
determining the indication of user sensory impairment based on the user profile.

9. A system for compensating for a user sensory impairment in a Web Real-Time Communications (WebRTC) interactive session, comprising:
at least one communications interface; and
a computing device associated with the at least one communications interface and comprising a sensory impairment compensation agent, the sensory impairment compensation agent configured to:
receive an indication of user sensory impairment;
receive a content of a WebRTC interactive flow directed to the computing device;
modify the content of the WebRTC interactive flow based on the indication of user sensory impairment; and
render the modified content of the WebRTC interactive flow.

10. The system of claim 9, wherein the sensory impairment compensation agent is configured to receive the indication of user sensory impairment by receiving an indication of user hearing impairment; and
wherein the sensory impairment compensation agent is configured to modify the content of the WebRTC interactive flow by modifying a real-time audio stream of the WebRTC interactive flow based on the indication of user hearing impairment.

11. The system of claim 10, wherein the sensory impairment compensation agent is configured to modify the real-time audio stream of the WebRTC interactive flow by modifying an amplitude of a first frequency in the real-time audio stream or substituting a second frequency for a third frequency in the real-time audio stream, or a combination thereof, based on the indication of user hearing impairment.

12. The system of claim 9, wherein the sensory impairment compensation agent is configured to receive the indication of user sensory impairment by receiving an indication of user vision impairment; and
wherein the sensory impairment compensation agent is configured to modify the content of the WebRTC interactive flow by modifying a real-time video stream of the WebRTC interactive flow based on the indication of user vision impairment.

13. The system of claim 12, wherein the sensory impairment compensation agent is configured to modify the real-time video stream of the WebRTC interactive flow by modifying an intensity of a first color in the real-time video stream or substituting a second color for a third color in the real-time video stream, or a combination thereof, based on the indication of user vision impairment.

14. The system of claim 9, wherein the sensory impairment compensation agent is configured to receive the indication of user sensory impairment by:
administering a sensory impairment assessment by the computing device; and
determining the indication of user sensory impairment based on a result of the sensory impairment assessment.

15. A non-transitory computer-readable medium having stored thereon computer-executable instructions to cause a processor to implement a method, comprising:
receiving, by a computing device, an indication of user sensory impairment;
receiving a content of a Web Real-Time Communications (WebRTC) interactive flow directed to the computing device;
modifying, by the computing device, the content of the WebRTC interactive flow based on the indication of user sensory impairment; and
rendering the modified content of the WebRTC interactive flow.

16. The non-transitory computer-readable medium of claim 15 having stored thereon the computer-executable instructions to cause the processor to implement the method wherein receiving the indication of user sensory impairment comprises receiving an indication of user hearing impairment; and
wherein modifying the content of the WebRTC interactive flow comprises modifying a real-time audio stream of the WebRTC interactive flow based on the indication of user hearing impairment.

17. The non-transitory computer-readable medium of claim 16 having stored thereon the computer-executable instructions to cause the processor to implement the method wherein modifying the real-time audio stream of the WebRTC interactive flow comprises modifying an amplitude of a first frequency in the real-time audio stream or substituting a second frequency for a third frequency in the real-time audio stream, or a combination thereof, based on the indication of user hearing impairment.

18. The non-transitory computer-readable medium of claim 15 having stored thereon the computer-executable instructions to cause the processor to implement the method wherein receiving the indication of user sensory impairment comprises receiving an indication of user vision impairment; and
wherein modifying the content of the WebRTC interactive flow comprises modifying a real-time video stream of the WebRTC interactive flow based on the indication of user vision impairment.

19. The non-transitory computer-readable medium of claim 18 having stored thereon the computer-executable instructions to cause the processor to implement the method wherein modifying the real-time video stream of the WebRTC interactive flow comprises modifying an intensity of a first color in the real-time video stream or substituting a second color for a third color in the real-time video stream, or a combination thereof, based on the indication of user vision impairment.

20. The non-transitory computer-readable medium of claim 15 having stored thereon the computer-executable instructions to cause the processor to implement the method wherein receiving the indication of user sensory impairment comprises:
administering a sensory impairment assessment by the computing device; and
determining the indication of user sensory impairment based on a result of the sensory impairment assessment.
